(19) United States
(12) Patent Application Publication
(10) Pub. No.: US 2026/0310432 A1
(43) Pub. Date: Oct. 8, 2026

(54) SYSTEMS AND METHODS FOR BLOCKING DEPLOYMENT OF UNSATISFACTORY FILES USING EVENT DETECTION

(71) Applicant: Capital One Services, LLC, McLean, VA (US)

(72) Inventors: Clayton Mottley, Falls Church, VA (US); Alexander Misihowsky, Jersey City, NJ (US); Theodore Timothy John, West Chester, PA (US); Nicholas Visalli, Laurel, MD (US); Madison Behm, Chicago, IL (US); Benjamin Lewinter, New York, NY (US); Kiran Rao, Salt Lake City, UT (US)

(73) Assignee: Capital One Services, LLC, McLean, VA (US)

(21) Appl. No.: 19/172,626

(22) Filed: Apr. 7, 2025

(51) Int. Cl. G06F 8/60

(52) U.S. Cl. CPC G06F 8/60

(57) ABSTRACT

A device may monitor an event bus of a development environment, implemented on a user device, while a document is open in the development environment. The device may detect based on monitoring the event bus, a sequence of events indicative of use of assistive content generation to generate candidate content in the document. The device may detect an inclusion of the candidate content in a file in a file repository, and the file may be designated for deployment in a serving system. The device may block, based on detecting the inclusion of the candidate content, the file from deployment in the serving system.

### BACKGROUND

Development environments, such as integrated development environments (IDEs), provide various tools to assist in creating and managing digital content, including code, text documents, and other structured data. Assistive content generation, such as assistive coding, has been integrated into these environments to improve productivity by suggesting, modifying, or automatically generating content. However, the use of assistive tools presents challenges, as the generated content may be unreliable, insecure, or contain errors that compromise the quality, security, or performance of the document. For example, generated code may introduce security vulnerabilities or produce unintended behaviors when executed.

### SUMMARY

Methods and systems are described herein for monitoring and controlling the deployment in a serving system (e.g., a production environment) of content produced through assistive content generation to enhance security and performance in the serving system. As one example, methods and systems are described herein for blocking the deployment of unreliable, insecure, or buggy content generated by generative tools, thereby enhancing the stability and security of serving systems.

Content, such as code, can be deployed to a serving system where it becomes accessible for processing or responding to requests from user devices. For example, user devices may interact with this content by sending network requests to the serving system, which processes the requests and generates appropriate responses or outputs. These responses or outputs are then transmitted from the serving system back to the user devices in the form of network responses, thereby fulfilling the requests of the user devices. However, if due to deficiencies of the content, the response is insufficient, irrelevant, or otherwise unsatisfactory, a user device may repeatedly send additional request messages until its demands are fully met. This continuous cycle of request and response requires substantial computing power from both the serving system and the user device for generating and processing messages, and additionally requires significant network resources to handle the communication of these messages.

In some examples, files deployed to the serving system may contain content produced through the use of assistive content generation. Assistive content generation, such as assistive coding, involves using tools (e.g., implemented through an extension of a development environment) to automatically generate content based on predefined criteria or inputs. Assistive content generation can significantly speed up the development process but may produce content that is unreliable, insecure, or buggy. This content, when included in files such as code files that are deployed to a serving system may cause instability, security vulnerabilities, stalling, premature introduction of incomplete features, and/or inadvertent rollback of features. Such issues can lead to system crashes, excessive occupation of processing resources, and data breaches, as well as inefficient use of processing resources because substantial efforts may be required to remediate the deployment of invalid, incomplete, insecure, or buggy content. Moreover, the generated content may be deficient, in that it fails to produce satisfactory responses or outputs to requests from user devices, thereby resulting in overutilization of network resources and processor resources in connection with user devices making repetitive requests in order to satisfy their demands.

To address these technical deficiencies, methods and systems disclosed herein enable detection of attempts to deploy files containing content produced through assistive content generation, and control of the deployment to block files that may be unreliable, insecure, or buggy. In some embodiments, a system may monitor an event bus of a development environment while a document is open. The monitoring may be performed using an extension of the development environment. Based on this monitoring, the system may detect sequences of events indicative of the use of assistive content generation. For example, the system may detect a sequence of a first event indicative of a presentation, in a document, of an inline element that contains candidate content, and a second event indicative of an input into a user device for accepting the candidate content into the code document (e.g., pressing a tab key, or the like). The detection of such a sequence may enable the system to detect the use of assistive content generation. Furthermore, the system may detect the inclusion of such candidate content in one or more files within a file repository designated for deployment in a serving system. Based on this detection, the system may determine whether the file(s) contain an excessive amount (or in some cases, an insufficient amount) of content produced using assistive content generation. If the system identifies an excessive amount (or in some cases, an insufficient amount) of content produced using assistive content generation, then the system may block the file(s) from being deployed in the serving system. This approach ensures that files having a probability of being unreliable, insecure, or buggy can be blocked before deployment into the serving system.

Blocking the deployment of a file that has a probability of being unreliable, insecure, or buggy improves the stability and performance of serving systems. For example, blocking the deployment of the file reduces system crashes and security breaches, as well as conserves processing resources that would otherwise be expended on remediating the deployment of invalid or buggy content. Moreover, by blocking the deployment of content that has a probability of failing to produce satisfactory responses or outputs to requests from user devices, techniques described herein minimize follow-up requests, thereby reducing redundant interactions between the serving system and user devices. This efficiency improves system performance by lowering processing and network overhead, reducing latency, and optimizing resource utilization.

In some embodiments, a system may monitor an event bus of a development environment, implemented on a user device, while a code document is open in the development environment. The system may detect, based on monitoring the event bus, a sequence of a first event indicative of a presentation, in the code document, of an inline element that contains candidate code, and a second event indicative of an input into the user device for accepting the candidate code into the code document. The system may identify, subsequent to the sequence of the first event and the second event, that the code document contains the candidate code, where detection of the sequence of the first event and the second event, and detection that the code document contains the candidate code is used to detect use of assistive coding in the code document. The system may detect an inclusion of the candidate code in a source code file in a code repository, where the source code file is designated for deployment in a serving system. The system may determine, based on detecting the inclusion of the candidate code, a proportion of code in the source code file that used assistive coding. The system may block, based on the proportion of code in the source code file satisfying a threshold, the source code file from deployment in the serving system.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIGS. 1A-1C show an example environment for blocking deployment of unsatisfactory files using event detection, in accordance with one or more embodiments.

FIG. 2 shows illustrative components for a system used to detect use of assistive content generation, in accordance with one or more embodiments.

FIG. 3 shows a flowchart of the steps involved in blocking deployment of unsatisfactory files using event detection, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

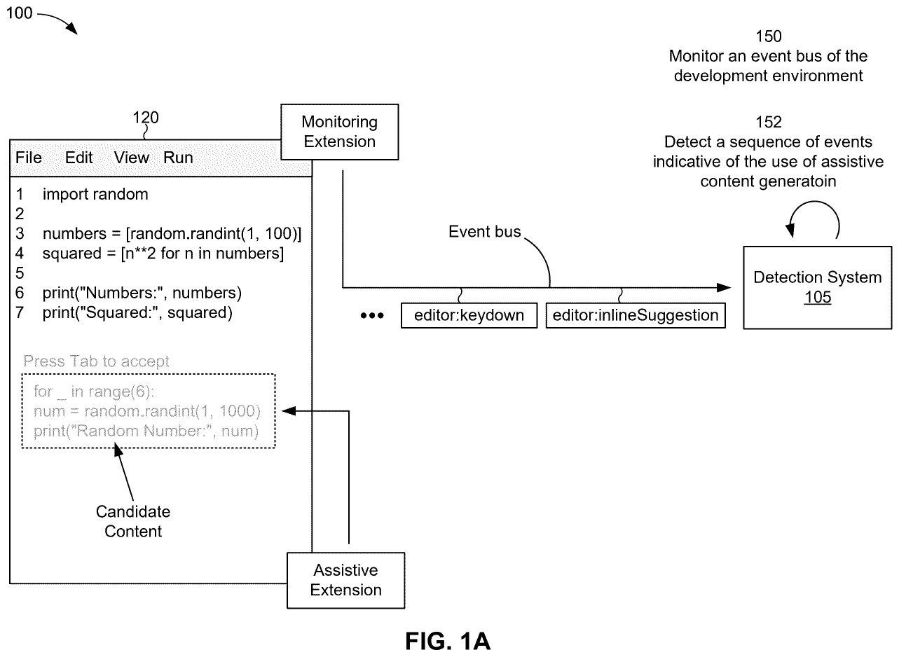

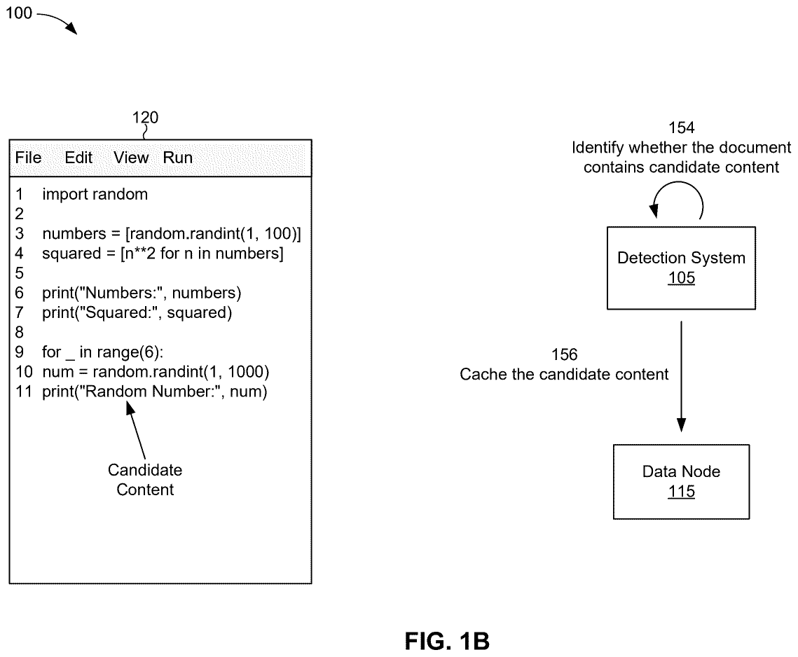

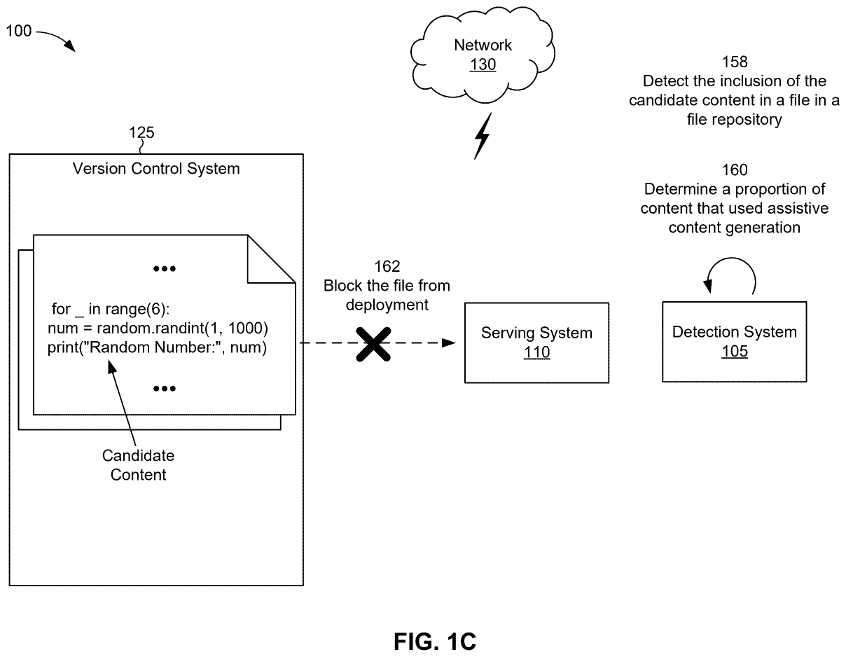

FIGS. 1A-1C show an example environment 100 for blocking deployment of unsatisfactory files using event detection, in accordance with one or more embodiments. As shown, the environment 100 includes a detection system 105, a serving system 110, a data node 115, a user device 120, a version control system 125, and/or a network 130.

Communication among the devices and systems of environment 100 may be performed via the network 130. The network 130 may include one or more wired and/or wireless networks. For example, the network 130 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. For example, communications among the devices and systems of environment 100 may be in the form of network messages (e.g., HTTP requests and responses, API requests and responses, or the like).

The data node 115 may include a data storage location (e.g., a data lake or a data warehouse), a memory, one or more data sources, one or more data services (e.g., accessible via an application programming interface (API)), and/or one or more databases, among other examples. The data node 115 may include, or may be included in, one or more servers. The data node 115 may store information relating to content snippets (e.g., code snippets) and/or users associated with content snippets. The data node 115 may provide any of the aforementioned information to the detection system 105 (e.g., via the network 130). In some embodiments, the data node 115 may be a component of the detection system 105.

The user device 120 may include a communication device and/or a computing device. For example, the user device 120 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 120 may implement a user interface facilitating user-computer interaction and communication, and may include display screens, keyboards, a mouse, and the appearance of a desktop. For example, a user interface may include a way a user interacts with an application or a website. The user device 120 may exchange data with the detection system 105. For example, data exchanged with the detection system 105 may be in connection with the user device 120 accessing a web page or an application.

The user device 120 may implement a development environment (e.g., an application). The “development environment” refers to a workspace that provides tools, interfaces, and functionalities for creating, editing, managing, and processing digital content or code. The development environment may include an integrated development environment (IDE), a code editor, a word processor, a presentation development environment, a photo editor, or another application that facilitates the creation and editing of digital content. In some examples, an assistive extension may be installed in the development environment that provides assistive content generation. In other examples, assistive content generation may be a native feature of the development environment. “Assistive content generation” may refer to automated or semi-automated creation, modification, or suggestion of digital content using computational techniques, including rule-based algorithms, artificial intelligence (AI), and/or machine learning models. For example, assistive content generation may include the assisted generation of code, text, and/or images, among other examples. As an example, assistive content generation may include assistive coding.

The version control system 125 tracks, manages, and organizes changes to digital files (e.g., code source files, word processing files, spreadsheet files, presentation files, image files, multimedia files, and/or HTML files) within a file repository or code repository, enabling multiple users to collaboratively develop, edit, and maintain content while preserving historical versions. The version control system 125 records modifications, associates changes with timestamps and user identities, and allows for branching, merging, and rollback operations to facilitate concurrent work and conflict resolution. Changes to the digital files may be recorded as commits, and the changes can be integrated through merging facilitated by pull requests or merge requests. A “commit” may refer to a recorded change to a file repository or code repository that captures modifications to one or more files, along with associated metadata such as a timestamp, author identity, and a unique identifier, to maintain version history and enable traceability.

The detection system 105 may include a communication device and/or a computing device. For example, the detection system 105 may include one or more physical servers, one or more virtual servers (e.g., executing on computing hardware), and/or cloud computing resources (e.g., executing on computing hardware used in a cloud computing environment). The serving system 110 may include a communication device and/or a computing device. For example, the serving system 110 may include one or more physical servers, one or more virtual servers (e.g., executing on computing hardware), and/or cloud computing resources (e.g., executing on computing hardware used in a cloud computing environment). In some embodiments, the serving system 110 may be implemented on an edge node of a network or of a cloud system (e.g., in a regional data center of the cloud system).

The serving system 110 may be configured to manage request traffic from user devices 120 made via the network 130. The serving system 110 may be an online system. “Online” may refer to an environment in which the execution of data processing tasks is performed in response to real-time user inputs. For example, the serving system 110 may provide responses to requests from user devices in real time. “Real time” may refer to the responses being provided within a time frame (e.g., within 2 seconds, within 1 second, or within 100 milliseconds) that is perceptibly concurrent or near-concurrent with the requests.

In some embodiments, communications between the detection system 105, the serving system 110, and/or the version control system 125 may be performed through the network 130. In other embodiments, communications between the detection system 105, the serving system 110, and/or the version control system 125 may be performed locally (e.g., within a cloud computing environment) rather than through the network 130. For example, the detection system 105, the serving system 110, and/or the version control system 125 may be implemented in the same cloud computing resource or in separate cloud computing resources within the same cloud computing environment. In some embodiments, the detection system 105, the serving system 110, and/or the version control system 125 may be components (e.g., co-located components or distributed components) of the same higher-level processing system. For example, the detection system 105, the serving system 110, and/or the version control system 125 may be hardware components or software components of the same system.

In some embodiments, the detection system 105 may include, or communicate with, a monitoring extension installed in the development environment. For example, the monitoring extension may provide monitoring and detection of events that indicate assistive content generation. The monitoring extension may be a separate and different extension than the assistive extension. In some examples, data and events of the development environment that can be retrieved and processed by the assistive extension cannot be retrieved and processed by the monitoring extension. Accordingly, the assistive extension may be able to directly detect use of assistive content generation in ways that the monitoring extension cannot. However, as described herein, the monitoring extension may employ various techniques to indirectly detect use of assistive content generation. In this way, the monitoring extension can be employed across different development environments to detect use of assistive content generation where native support for doing so is lacking in the development environment.

As shown in FIG. 1A, and by reference number 150, the detection system 105 (e.g., using the monitoring extension) may monitor an event bus of the development environment. The “event bus” (sometimes referred to as a message bus, an event stream, or an event dispatcher) may refer to a communication mechanism that facilitates the transmission of events between different components within the development environment, allowing event producers to publish messages that event consumers can subscribe to and process asynchronously or synchronously. In some embodiments, the event bus may interact with API hooks to facilitate event handling.

The detection system 105 may monitor the event bus while a document is open (e.g., being edited or otherwise editable) in the development environment. The document may be a code document, a word processing document, a spreadsheet document, a presentation document, a web page, or the like. When monitoring the event bus, the detection system 105 may listen for particular events that in combination (e.g., in sequence) are indicative of the use of assistive content generation. In some embodiments, the detection system 105 may monitor the event bus using an event listener of the monitoring extension. For example, using the monitoring extension, the detection system 105 may subscribe to the event bus to listen for particular events by registering event handlers that are triggered when corresponding events occur.

As shown by reference number 152, based on monitoring the event bus, the detection system 105 may detect a sequence of events (e.g., notifications) indicative of the use of assistive content generation in the document. As described herein, the sequence of events may include at least one event indicative of an input into the user device 120.

In one example, the detection system 105 may detect a presentation event indicative of a presentation, in the document, of an inline element (e.g., inline content, an inlay, or the like). The presentation of the inline element may be caused by the assistive extension. The inline element may contain candidate content (e.g., candidate code). “Candidate content” may refer to content having a probability of being generated through the use of assistive content generation. For example, the inline element may contain a suggestion of content to insert into the document. However, because inline elements may also be used for other purposes in the development environment, the exact nature of the contents of the inline element may be unknown to the detection system 105. Accordingly, based on the presentation event alone, the detection system 105 may be unable to ascertain the use of assistive content generation.

The presentation event may be a native presentation event of the development environment. A “native event” may refer to an event that is particular to the development environment, but not universally applicable across different development environments. For example, a native event may be a type of event on the event bus that is recognized in the development environment, but not recognized in other development environments. In some embodiments, the detection system 105 may normalize the native presentation event to a common event that is independent of any development environment. For example, the native presentation event indicative of the presentation of the inline element can be normalized to a common event that indicates that candidate content has been shown in the development environment. This abstraction of native events to common events allows the detection system 105 to convert environment-dependent events to an environment-independent format that facilitates consistent processing and detection of assistive content generation regardless of the particular development environment being used.

In sequence with the presentation event (e.g., immediately following the presentation event or within a time period after the presentation event), the detection system 105 may detect an acceptance input event indicative of an input (e.g., a keystroke) in the user device 120. For example, the acceptance input event may indicate an inputting of a tab key, a spacebar key, an enter key, a mouse click, a screen tap, or the like. The input in the user device 120 may have a probability of indicating acceptance of the candidate content for insertion into the document. However, because inputs may also be used for other purposes in the development environment, the exact nature of the input may be unknown to the detection system 105. Nevertheless, based on detecting the presentation event and the acceptance input event in sequence, the detection system 105 may detect use of assistive content generation (e.g., the candidate content was generated using assistive content generation). For example, the detection system 105 may detect the use of assistive content generation based on the acceptance input event being the immediate next event following the presentation event. As another example, the detection system 105 may detect the use of assistive content generation based on the acceptance input event occurring within a threshold time (e.g., 2 seconds or 5 seconds) of the presentation event. In contrast, if a different event followed the presentation event, such as one or more events indicative of typing into the user device 120, then the detection system 105 may determine that assistive content generation is not being used.

The acceptance input event may be a native acceptance input event of the development environment. In some embodiments, the detection system 105 may normalize the acceptance input native event to a common event that is independent of any development environment. For example, the acceptance input event indicative of the input into the user device 120 can be normalized to a common event that indicates acceptance of the candidate content. Accordingly, the determination that assistive content generation has been used in the document may be based on the common event that indicates candidate content has been shown and the common event that indicates acceptance of the candidate content.

In another example, the detection system 105 may detect a request input event indicative of a first input into the user device 120. The first input may be for an input to an assistive system of the development environment (e.g., an assistive system implemented by the assistive extension). For example, the assistive system may be a chatbot, a question-and-answer system, a generative AI system, or the like, and the first input may be a prompt for inputting to the assistive system. As an example, the first input may be a request for assistive content generation. However, because requests to the assistive system may also be made for other purposes in the development environment, the exact nature of the request may be unknown to the detection system 105. Accordingly, based on the request input event alone, the detection system 105 may be unable to ascertain the use of assistive content generation. In some embodiments, the detection system 105 may normalize the native request input event to a common event indicating submission of a request for content, as described herein.

In sequence with the request input event (e.g., immediately following the request input event or within a time period after the request input event), the detection system 105 may detect an insertion event indicative of a second input (e.g., a keystroke or combination of keystrokes) into the user device 120. The second input may be for insertion of an output of the assistive system into the document (e.g., a copy and pasting of the output into the document). For example, the assistive system may output a response to the request for assistive content generation, and the response may contain candidate content. However, because outputs of the assistive system may also occur for other purposes in the development environment, the exact nature of the output may be unknown to the detection system 105. Nevertheless, based on detecting the request input event and the insertion input event in sequence, the detection system 105 may detect use of assistive content generation. For example, the detection system 105 may detect the use of assistive content generation based on the insertion input event being the immediate next event following the request input event. As another example, the detection system 105 may detect the use of assistive content generation based on the insertion input event occurring within a threshold time (e.g., 2 seconds or 5 seconds) of the request input event. In some embodiments, the detection system 105 may normalize the native insertion input event to a common event indicating insertion of candidate content, as described herein. Accordingly, the determination that assistive content generation has been used in the document may be based on the common event that indicates submission of a request for content and the common event that indicates insertion of candidate content.

In some examples, the detection system 105 may detect the use of assistive content generation based on a sequence with a combination of the presentation event, the acceptance input event, the request input event, and/or the insertion input event. Additionally, or alternatively, sequences with other types of events may also be used by the detection system 105 to detect the use of assistive content generation.

In some embodiments, the detection system 105 may detect an increase to a length (e.g., a number of characters or words) of the document that coincides with (e.g., concurrently with or immediately following) the acceptance input event or the insertion input event. Thus, the increase to the length of the document provides further confirmation that the acceptance input event or the insertion input event incorporated the candidate content into the document. Based on detecting the sequence of the presentation event and the acceptance input event (as well as the increase to the length, in some examples), the detection system 105 may extract the candidate content from the inline element. Similarly, based on detecting the sequence of the request input event and the insertion input event (as well as the increase to the length, in some examples), the detection system 105 may extract the candidate content from the output of the assistive system. In some embodiments, to extract the candidate content, the detection system 105 may access an API of the assistive system and/or an API of the development environment to retrieve the inline element contents or the output of the assistive system.

As shown in FIG. 1B, and by reference number 154, the detection system 105 may identify whether the document contains the candidate content. For example, the detection system 105 may identify whether the document contains the candidate content subsequent to detecting the sequence of the presentation event and the acceptance input event and/or the sequence of the request input event and the insertion input event. As an example, using the extracted candidate content as a reference pattern, the detection system 105 may scan the document for the candidate content to identify whether the document contains the candidate content. Thus, identifying the candidate content in the document provides further confirmation that the sequence of the presentation event and the acceptance input event and/or the sequence of the request input event and the insertion input event were associated with incorporating the candidate content into the document. Accordingly, the detection system 105 may detect use of assistive content generation in the document based on detecting the sequence of the presentation event and the acceptance input event and/or the sequence of the request input event and the insertion input event, as well as detecting that the document contains the candidate content. In contrast, if the detection system 105 detects that the document does not contain the candidate content, then the detection system 105 may determine that assistive content generation is not being used.

Based on detecting the use of assistive content generation in connection with the candidate content (e.g., the candidate content is determined to have been generated in an automated or semi-automated manner), as shown by reference number 156, the detection system 105 may cache the candidate content (e.g., as a content snippet, such as a code snippet). For example, the detection system 105 may cache the candidate content at the data node 115 and/or locally. The candidate content may be cached with an association to a user of the user device 120 (e.g., using a user identifier for the user, such as a name or an identifier number). The user of the user device 120 may also be the author of the document. The association of the candidate content with the user indicates that assistive content generation was used by the user while editing the document. In some embodiments, the data point (e.g., the candidate content and user) may be enriched with additional data that the detection system 105 may extract from the development environment (e.g., by accessing an API of the development environment), such as a file name of the document, a type of the document (e.g., a code document, a word processing document, etc.) a language or programming language used in the document, and/or source control information including branch name, commit history, and/or remote repository details (e.g., in connection with use of the version control system 125 by the development environment).

As shown in FIG. 1C, and by reference number 158, the detection system 105 may detect the inclusion of the candidate content (e.g., candidate code) in a file (e.g., a source code file) in a file repository (e.g., a code repository) of the version control system 125. The file in which the candidate content is detected may be designated for deployment in the serving system 110. For example, the file may be in a queue for upload to the serving system 110, may be associated with a pull request, may be associated with a merge request, may be in a list of files scheduled for deployment, or the like.

To detect the inclusion of the candidate content in a file, the detection system 105 may monitor the file repository (e.g., via an API of the version control system 125) for any modifications to files in the file repository, and thus detect a modification to a file based on monitoring the file repository. In some examples, the detection system 105 may monitor the file repository and detect modifications by tracking file metadata, such as the files' last updated date or user that last modified, to detect when a file has been edited or replaced. Additionally, or alternatively, the detection system 105 may monitor the file repository and detect modifications based on upload activity to the file repository, by tracking changes to the files' sizes, and/or by tracking when files are added or deleted within the file repository. In some examples, the detection system 105 may monitor the file repository (e.g., a code repository) for and to detect a new commit to the file repository, where the new commit indicates modification to one or more files (e.g., source code files) in the file repository.

Based on detecting the modified file, and because that modified file has the potential to include content derived from assistive content generation, the detection system 105 may next determine whether such content, and how much of such content, is present in the modified file. In some embodiments, the detection system 105 may identify the new content (e.g., new code) that is present in the modified file. The detection system 105 may identify new content in the modified file by analyzing differences between the file's current version and a previously stored version, such as by comparing text or other content between the two versions. In some examples, the detection system 105 may use the new commit to identify the new content by extracting the changes recorded in the commit, including added, removed, and/or modified portions of the file as tracked by the version control system 125. The detection system 105 may also retrieve from the cache the saved content snippets (including the cached candidate content), such as the saved content snippets that were saved within a threshold time before detection of the modified file. In some embodiments, the detection system 105 may determine (e.g., using file metadata or information in the new commit) that the modifications to the file were made by the user (e.g., the same user that used assistive content generation while editing the document, as described herein), and the detection system 105 may retrieve the candidate content, as well as any other content snippets, from the cache that are associated with the user.

The detection system 105 may then compare the new content with the saved content snippets, including the candidate content, that were retrieved (e.g., which can be saved content snippets across several users or those particular to the user). In some embodiments, the comparison may use a rough similarity search that can identify approximate matches between the new content and the saved content snippets by comparing their features using heuristics, probabilistic models, and/or distance metrics to account for variations, errors, or partial similarities. Based on the comparison, the detection system 105 may determine that the candidate code, and possibly one or more other content snippets, are present in the new content. In this way, the detection system 105 may determine that the new content, and therefore the modified file, contains content that used assistive content generation. In some embodiments, the detection system 105 may store information (e.g., in the data node 115) associating the candidate content with the modified file(s) (e.g., using a commit identifier).

As shown by reference number 160, based on detecting the inclusion of the candidate content, and possibly one or more other content snippets, in the file, the detection system 105 may determine a proportion of content in the modified file(s) that used assistive content generation (e.g., assistive coding). For example, the detection system 105 may determine a proportion of all content snippets found in the modified file(s) to a total content in the modified file(s). The proportion can be based on number of characters, number of words, number of bytes, or the like. The detection system 105 may then determine whether the proportion satisfies a threshold. In some examples, it may be desirable to have a significant amount of content that uses assistive content generation, and therefore, the detection system 105 may be checking whether the proportion is greater than a threshold. In other examples, it may be undesirable to have a significant amount of content that used assistive content generation, and therefore, the detection system 105 may be checking whether the proportion is less than a threshold. In some embodiments, the detection system 105 may determine the threshold based on an experience level of the user that used the assistive content generation. For example, if assistive content generation is undesirable, then the threshold may be set to allow more content using assistive content generation for more experienced users.

As shown by reference number 162, the detection system 105 may block the file from deployment in the serving system 110. For example, the detection system 105 may block the file from deployment based on the proportion of content in the modified file(s) that used assistive content generation satisfying the threshold (e.g., if there is too much of such content in an example where such content is undesirable, or if there is too little of such content in an example where such content is desirable). Conversely, the detection system 105 may cause deployment of the file based on the proportion of content in the modified file(s) that used assistive content generation not satisfying the threshold or satisfying a different threshold. Deployment to the serving system 110 may include making the file available for access, execution, or distribution within the serving system 110. For example, deployment to the serving system 110 may include transferring the file to the serving system 110, publishing the file in the serving system 110, hosting the file in the serving system, or the like.

Blocking the file from deployment may include deleting the file, renaming the file, configuring restrictive access permissions for the file, marking the file as quarantined, and/or preventing the file from being included in a build or deployment pipeline (e.g., by updating a build configuration to exclude the file from compilation or packaging, renaming the file with an ignore indicator that prevents it from being included in builds, or moving the file to an ignore directory that prevents it from being included in builds), among other examples. In some examples, the detection system 105 may receive a request to deploy the file to the serving system 110 (e.g., a pull request, a merge request, or the like), and the detection system 105 may terminate the request in order to block the file from deployment. For example, to do so, the detection system 105 may reject the request, may configure a validation check to fail if the file is detected, may implement a hook to reject a merge that includes the file, or the like.

By blocking the file from deployment, the detection system 105 reduces instability, security vulnerabilities, premature introduction of incomplete features, inadvertent rolling back of features, or the like, that may otherwise occur. Thus, the detection system 105 improves the stability, functionality, and security of the serving system 110. Moreover, the detection system 105 allows for conservation of substantial processing resources that may otherwise be expended toward remediating deployment of content that is invalid, incomplete, insecure, or buggy.

In some embodiments, after blocking the deployment, the detection system 105 may perform operations to improve the content sufficiently for deployment in the serving system 110. For example, the detection system 105 may validate the content in the file by performing static analysis to identify syntax errors, security vulnerabilities, or deviations from standards. The detection system 105 may also execute test cases or simulations to check for functional correctness, performance issues, or unintended behaviors. Additionally, the detection system 105 may apply machine learning models or rule-based heuristics to assess the quality, security, and maintainability of the contents, and provide suggested improvements. In some embodiments, after blocking the deployment, the detection system 105 may transmit a message with a request for authorization to deploy the file(s), and receive a message indicating authorization to deploy the file(s). In some embodiments, after blocking the deployment, the detection system 105 may cause deployment of the file(s) based on the improvements to the content and/or the authorization to deploy the file(s).

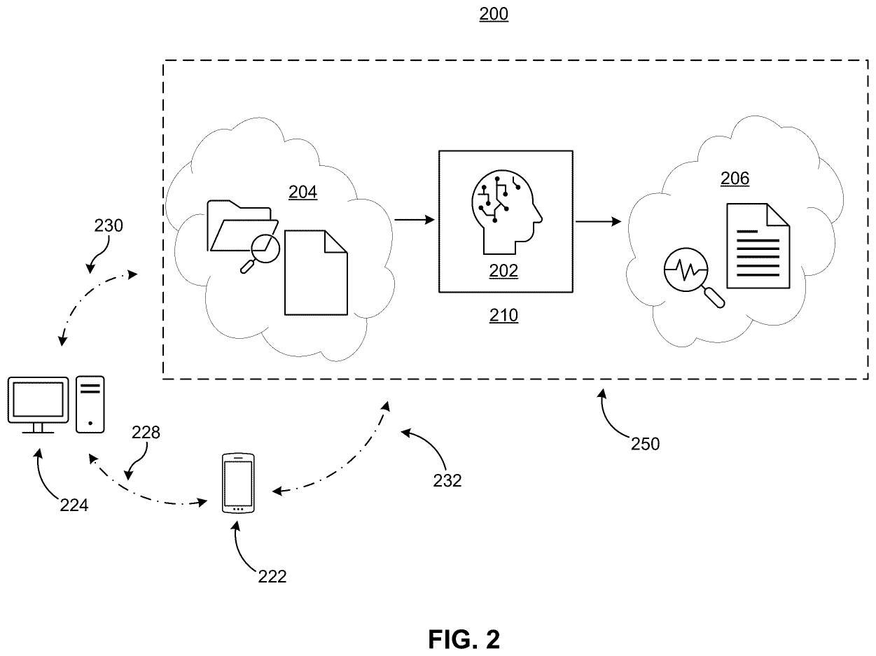

FIG. 2 shows illustrative components for a system used to detect use of assistive content generation, in accordance with one or more embodiments. For example, FIG. 2 may show illustrative components for detecting use of assistive content generation and blocking deployment of files based on detecting use of assistive content generation. As shown in FIG. 2, system 200 may include mobile device 222 and user terminal 224. While shown as a smartphone and personal computer, respectively, in FIG. 2, it should be noted that mobile device 222 and user terminal 224 may be any computing device, including, but not limited to, a laptop computer, a tablet computer, a hand-held computer, and other computer equipment (e.g., a server), including “smart,” wireless, wearable, and/or mobile devices. FIG. 2 also includes cloud components 210. Cloud components 210 may alternatively be any computing device as described above, and may include any type of mobile terminal, fixed terminal, or other device. For example, cloud components 210 may be implemented as a cloud computing system, and may feature one or more component devices. It should also be noted that system 200 is not limited to three devices. Users may, for instance, utilize one or more devices to interact with one another, one or more servers, or other components of system 200. It should be noted, that, while one or more operations are described herein as being performed by particular components of system 200, these operations may, in some embodiments, be performed by other components of system 200. As an example, while one or more operations are described herein as being performed by components of mobile device 222, these operations may, in some embodiments, be performed by components of cloud components 210. In some embodiments, the various computers and systems described herein may include one or more computing devices that are programmed to perform the described functions. Additionally, or alternatively, multiple users may interact with system 200 and/or one or more components of system 200. For example, in one embodiment, a first user and a second user may interact with system 200 using two different components.

With respect to the components of mobile device 222, user terminal 224, and cloud components 210, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 2, both mobile device 222 and user terminal 224 include a display upon which to display data (e.g., conversational response, queries, and/or notifications).

Additionally, as mobile device 222 and user terminal 224 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 200 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 2 also includes communication paths 228, 230, and 232. Communication paths 228, 230, and 232 may include the Internet, a mobile phone network, a mobile voice or data network (e.g., a 5G or LTE network), a cable network, a public switched telephone network, or other types of communications networks or combinations of communications networks. Communication paths 228, 230, and 232 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 210 may include detection system 105, serving system 110, data node 115, user device 120, and/or version control system 125. Cloud components 210 may access data node 115.

Cloud components 210 may include model 202, which may be a machine learning model, artificial intelligence model, etc. (which may be referred collectively as “models” herein). Model 202 may take inputs 204 and provide outputs 206. The inputs may include multiple datasets, such as a training dataset and a test dataset. Each of the plurality of datasets (e.g., inputs 204) may include data subsets related to user data, predicted forecasts and/or errors, and/or actual forecasts and/or errors. In some embodiments, outputs 206 may be fed back to model 202 as input to train model 202 (e.g., alone or in conjunction with user indications of the accuracy of outputs 206, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., whether assistive content generation is used).

In a variety of embodiments, model 202 may update its configurations (e.g., weights, biases, or other parameters) based on the assessment of its prediction (e.g., outputs 206) and reference feedback information (e.g., user indication of accuracy, reference labels, or other information). In a variety of embodiments, where model 202 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 202 may be trained to generate better predictions.

In some embodiments, model 202 may include an artificial neural network. In such embodiments, model 202 may include an input layer and one or more hidden layers. Each neural unit of model 202 may be connected with many other neural units of model 202. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 202 may be self-learning and trained, rather than explicitly programmed, and can perform significantly better in certain areas of problem solving, as compared to traditional computer programs. During training, an output layer of model 202 may correspond to a classification of model 202, and an input known to correspond to that classification may be input into an input layer of model 202 during training. During testing, an input without a known classification may be input into the input layer, and a determined classification may be output.

In some embodiments, model 202 may include multiple layers (e.g., where a signal path traverses from front layers to back layers). In some embodiments, back propagation techniques may be utilized by model 202 where forward stimulation is used to reset weights on the “front” neural units. In some embodiments, stimulation and inhibition for model 202 may be more free-flowing, with connections interacting in a more chaotic and complex fashion. During testing, an output layer of model 202 may indicate whether or not a given input corresponds to a classification of model 202 (e.g., assistive-generated content or user-generated content).

In some embodiments, the model (e.g., model 202) may automatically perform actions based on outputs 206. In some embodiments, the model (e.g., model 202) may not perform any actions. The output of the model (e.g., model 202) may be used to block deployment of files to a serving system.

System 200 also includes API layer 250. API layer 250 may allow the system to generate summaries across different devices. In some embodiments, API layer 250 may be implemented on mobile device 222 or user terminal 224. Alternatively or additionally, API layer 250 may reside on one or more of cloud components 210. API layer 250 (which may be A REST or Web services API layer) may provide a decoupled interface to data and/or functionality of one or more applications. API layer 250 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 250 may use various architectural arrangements. For example, system 200 may be partially based on API layer 250, such that there is strong adoption of SOAP and RESTful Web-services, using resources like Service Repository and Developer Portal, but with low governance, standardization, and separation of concerns. Alternatively, system 200 may be fully based on API layer 250, such that separation of concerns between layers like API layer 250, services, and applications are in place.

In some embodiments, the system architecture may use a microservice approach. Such systems may use two types of layers: Front-End Layer and Back-End Layer where microservices reside. In this kind of architecture, the role of the API layer 250 may provide integration between Front-End and Back-End. In such cases, API layer 250 may use RESTful APIs (exposition to front-end or even communication between microservices). API layer 250 may use AMQP (e.g., Kafka, RabbitMQ, etc.). API layer 250 may use incipient usage of new communications protocols such as gRPC, Thrift, etc.

In some embodiments, the system architecture may use an open API approach. In such cases, API layer 250 may use commercial or open source API Platforms and their modules. API layer 250 may use a developer portal. API layer 250 may use strong security constraints applying WAF and DDoS protection, and API layer 250 may use RESTful APIs as standard for external integration.

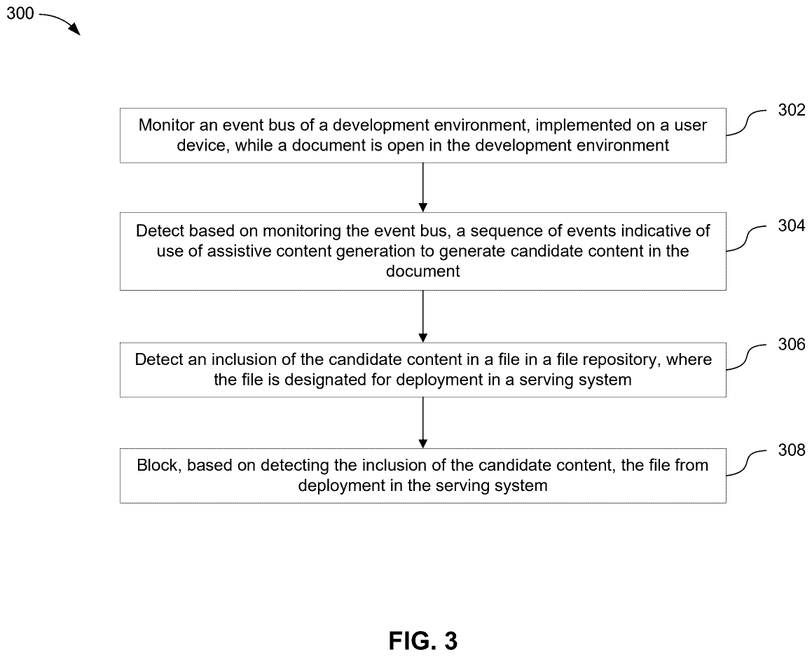

FIG. 3 shows a flowchart of the steps involved in blocking deployment of unsatisfactory files using event detection, in accordance with one or more embodiments. For example, the system may use process 300 (e.g., as implemented on one or more system components described above) in order to detect use of assistive content generation and block deployment of files based on detecting use of assistive content generation.

At step 302, process 300 (e.g., using one or more components described above) may include monitoring an event bus of a development environment implemented on a user device. For example, the system may monitor an event bus of a development environment, implemented on a user device, while a document is open in the development environment, as described herein. As an example, as described in connection with reference number 150 of FIG. 1A, monitoring the event bus may include listening for particular events that in combination (e.g., in sequence) are indicative of the use of assistive content generation. For example, monitoring the event bus may include monitoring the event bus using an event listener of an extension of the development environment. By doing so, the system can proactively detect instances of assistive content generation and differentiate between user-authored and automatically generated content. This enables real-time analysis and validation of generated content, helping to identify potential errors, security vulnerabilities, or inconsistencies before they propagate through the development process.

At step 304, process 300 (e.g., using one or more components described above) may include detecting, based on monitoring the event bus, a sequence of events indicative of use of assistive content generation. For example, the system may detect, based on monitoring the event bus, a sequence of events indicative of use of assistive content generation to generate candidate content in the document, as described herein. As an example, as described in connection with reference number 152 of FIG. 1A, the sequence of events may include at least one event indicative of an input into the user device. For example, the system may use input events in combination with other events to infer when content produced using assistive content generation has been incorporated into the document. By doing so, the system can automatically identify and track assistive-generated content, allowing for more precise handling of such content within the development environment. This enables improved validation and filtering mechanisms, ensuring that generated content meets quality, security, and compliance requirements before it is integrated or deployed. Additionally, by detecting assistive content in real time, the system can provide targeted feedback, recommendations, or restrictions, helping users make informed decisions about incorporating the content. This approach enhances the reliability and security of documents by reducing the risk of unintentionally using flawed or non-compliant generated content.

In some embodiments, detecting the sequence of events may include detecting a first event indicative of a presentation, in the document, of an inline element that contains the candidate content, and detecting a second event indicative of an input into the user device for accepting the candidate content into the document. The detection of the sequence of the first event and the second event may be used to detect use of assistive content generation. By detecting the first event and the second event, the use of assistive content generation can be inferred in real-time with minimal intrusiveness and without expending significant processing resources relative to other detection techniques, such as machine learning techniques. In some embodiments, process 300 may include identifying, subsequent to the sequence of the first event and the second event, that the document contains the candidate content. Detection of the sequence of the first event and the second event, and detection that the document contains the candidate content may be used to detect use of assistive content generation in the document. By providing additional checks such as this, the use of assistive content generation can be detected with greater certainty, thereby reducing false positives that could otherwise lead to additional and unnecessary processing.

In some embodiments, detecting the sequence of events may include detecting a first event indicative of a presentation, in the document, of an inline element, where the first event is a first native event of the development environment, normalizing the first native event to a first common event that is independent of any development environment, where the first common event indicates the candidate content being shown, detecting a second event indicative of an input into the user device, where the second event is a second native event of the development environment, normalizing the second native event to a second common event that is independent of any development environment, where the second common event indicates acceptance of the candidate content, and determining, based on the first common event and the second common event, use of assistive content generation in the document. This abstraction of native events to common events allows the system to convert environment-dependent events to an environment-independent format that facilitates consistent processing and detection of assistive content generation regardless of the particular development environment being used.

In some embodiments, detecting the sequence of events may include detecting a first event indicative of a first input into the user device relating to an input to an assistive system of the development environment, and detecting a second event indicative of a second input into the user device for insertion of an output of the assistive system into the document. The detection of the sequence of the first event and the second event may be used to detect use of assistive content generation. By detecting the first event and the second event, the use of assistive content generation can be inferred in real-time with minimal intrusiveness and without expending significant processing resources relative to other detection techniques, such as machine learning techniques.

In some embodiments, process 300 may include caching the candidate content with an association to a user of the user device. Caching the candidate content with an association to the user enables accurate tracking and retrieval of assistive-generated content particular to the user.

At step 306, process 300 (e.g., using one or more components described above) may include detecting an inclusion of the candidate content in a file in a file repository. For example, the system may detect an inclusion of the candidate content in a file in a file repository, and the file may be one that is designated for deploying in a serving system, as described herein. As an example, as described in connection with reference number 158 of FIG. 1C, the file may be designated for deploying in the serving system if it is in a queue for upload to the serving system, if it is associated with a pull request, if it is associated with a merge request, if it is in a list of files scheduled for deployment, or the like. By doing so, the system can proactively identify and track assistive-generated content as it progresses toward deployment, enabling better oversight and quality control. This allows for automated validation and policy enforcement, ensuring that generated content complies with security, reliability, and governance standards before it is incorporated into a live environment. Additionally, by detecting assistive-generated content at this stage, the system can trigger pre-deployment review processes, such as automated testing, security scanning, or requiring manual approval. This approach helps reduce the risk of deploying flawed, low-quality, or insecure content, improving the overall stability, security, and performance of the deployment system.

In some embodiments, detecting the inclusion of the candidate content in the file in the file repository may include monitoring the file repository for modifications to a plurality of files in the file repository, detecting, based on monitoring the file repository, a modification to the file, and detecting, based on detecting the modification to the file, the inclusion of the candidate content in the file. Monitoring the file repository for modifications to files enables efficient and early detection of assistive-generated content, allowing for proactive validation, policy enforcement, and prevention of non-compliant or erroneous content from progressing toward deployment.

In some embodiments, detecting the inclusion of the candidate content in the file in the file repository may include detecting that a modification to the file is made by the user, and retrieving the candidate content from a cache based on the association to the user. Retrieving the candidate content from a cache based on the user's association enables efficient and accurate tracking of modifications, ensuring that assistive-generated content is correctly identified, validated, and managed throughout the development process.

In some embodiments, detecting the inclusion of the candidate content in the file of the file repository may include detecting a commit to a code repository, comparing new code of the commit with candidate code snippets that have been detected within a threshold time before detection of the commit, and determining, based on comparing the new code with the candidate code snippets, that candidate code is present in the new code. Comparing new code in a commit with recently detected candidate code snippets enables accurate tracking of assistive-generated content, allowing for prevention of unreliable, insecure, or buggy code from being integrated into the code repository and causing instability or security flaws in the serving system.

At step 308, process 300 (e.g., using one or more components described above) may include blocking the file from deployment in the serving system. For example, the system may block, based on detecting the inclusion of the candidate content, the file from deployment in the serving system, as described herein. As an example, as described in connection with reference number 162 of FIG. 1C, the file may be blocked from deployment in the serving system if there is too much (or in some cases, too little) content produced using assistive content generation. The system can prevent potentially unreliable, insecure, or non-compliant content from being deployed, reducing the prevalence of errors or vulnerabilities in the serving system. This can reduce system crashes and security breaches, as well as conserve processing resources that would otherwise be expended on remediating the deployment of invalid or buggy content. Moreover, by blocking the deployment of content that has a probability of failing to produce satisfactory responses or outputs to requests from user devices, follow-up requests can be minimized, thereby reducing redundant interactions between the serving system and user devices. This efficiency improves system performance by lowering processing and network overhead, reducing latency, and optimizing resource utilization.

In some embodiments, process 300 may include determining, based on detecting the inclusion of the candidate content, a proportion of content in the file that used assistive content generation, and determining whether the proportion of the content satisfies a threshold. Thus, blocking the file from deployment may include blocking the file from deployment based on the proportion of the content satisfying the threshold. Doing so ensures that files maintain an appropriate balance of user-created and generated content before deployment, thereby reducing instances of deploying unreliable, insecure, or buggy content. In some embodiments, process 300 may include determining the threshold based on an experience level of the user. In this way, the balance of user-created and generated content that is allowed can be dynamically adjusted.

In some embodiments, blocking the file from deployment in the serving system may include receiving a request to deploy the file to the serving system, and terminating the request. Terminating the request prevents unauthorized or unintended introduction of unreliable, insecure, or buggy content into the serving system, thereby improving the stability and performance of the serving system.

It is contemplated that the steps or descriptions of FIG. 3 may be used with any other embodiment of this disclosure. In addition, the steps and descriptions described in relation to FIG. 3 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 3.

In some embodiments, an Application-Specific Integrated Circuit (ASIC) may be configured to perform operations described herein. An ASIC is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model's computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC's capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for blocking deployment of unsatisfactory files using event detection.
2. The method of embodiment 1, comprising: monitoring, by a device, an event bus of a development environment, implemented on a user device, while a document is open in the development environment; detecting, by the device, based on monitoring the event bus, a sequence of events indicative of use of assistive content generation to generate candidate content in the document; detecting, by the device, an inclusion of the candidate content in a file in a file repository, wherein the file is designated for deployment in a serving system; and blocking, by the device and based on detecting the inclusion of the candidate content, the file from deployment in the serving system.
3. The method of any of embodiments 1-2, wherein detecting the sequence of events comprises: detecting a first event indicative of a presentation, in the document, of an inline element that contains the candidate content; and detecting a second event indicative of an input into the user device for accepting the candidate content into the document, wherein detection of the sequence of the first event and the second event is used to detect use of assistive content generation.
4. The method of embodiment 3, further comprising: identifying, subsequent to the sequence of the first event and the second event, that the document contains the candidate content, wherein detection of the sequence of the first event and the second event, and detection that the document contains the candidate content, is used to detect use of assistive content generation in the document.
5. The method of any of embodiments 1-4, wherein detecting the sequence of events comprises: detecting a first event indicative of a presentation, in the document, of an inline element, wherein the first event is a first native event of the development environment; normalizing the first native event to a first common event that is independent of any development environment, wherein the first common event indicates the candidate content being shown; detecting a second event indicative of an input into the user device, wherein the second event is a second native event of the development environment; normalizing the second native event to a second common event that is independent of any development environment, wherein the second common event indicates acceptance of the candidate content; and determining, based on the first common event and the second common event, use of assistive content generation in the document.
6. The method of any of embodiments 1-5, wherein detecting the sequence of events comprises: detecting a first event indicative of a first input into the user device relating to an input to an assistive system of the development environment; and detecting a second event indicative of a second input into the user device for insertion of an output of the assistive system into the document, wherein detection of the sequence of the first event and the second event is used to detect use of assistive content generation.
7. The method of any of embodiments 1-6, wherein monitoring the event bus comprises: monitoring the event bus using an event listener of an extension of the development environment. 8. The method of embodiment 7, wherein the candidate content is generated by an additional extension of the development environment. 9. The method of any of embodiments 1-8, wherein detecting the inclusion of the candidate content in the file in the file repository comprises: monitoring the file repository for modifications to a plurality of files in the file repository; detecting, based on monitoring the file repository, a modification to the file; and detecting, based on detecting the modification to the file, the inclusion of the candidate content in the file. 10. The method of any of embodiments 1-9, further comprising: caching the candidate content with an association to a user of the user device. 11. The method of embodiment 10, wherein detecting the inclusion of the candidate content in the file in the file repository comprises: detecting that a modification to the file is made by the user; and retrieving the candidate content from a cache based on the association to the user. 12. The method of any of embodiments 1-11, further comprising: determining, based on detecting the inclusion of the candidate content, a proportion of content in the file that used assistive content generation; and determining whether the proportion of the content satisfies a threshold, wherein blocking the file from deployment comprises: blocking the file from deployment based on the proportion of the content satisfying the threshold. 13. The method of embodiment 12, further comprising: determining the threshold based on an experience level of a user of the user device. 14. The method of any of embodiments 1-13, wherein blocking the file from deployment in the serving system comprises: receiving a request to deploy the file to the serving system; and terminating the request. 15. The method of any of embodiments 1-14, wherein detecting the inclusion of the candidate content in the file in the file repository comprises: detecting the inclusion of candidate code in a source code file of a code repository. 16. The method of embodiment 15, wherein detecting the inclusion of the candidate code in the source code file of the code repository comprises: detecting a commit to the code repository; comparing new code of the commit with candidate code snippets that have been detected within a threshold time before detection of the commit; and determining, based on comparing the new code with the candidate code snippets, that the candidate code is present in the new code. 17. One or more non-transitory, computer-readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for blocking deployment of unsatisfactory files using event detection, the system comprising:
one or more processors; and
one or more memories storing instructions that, when executed by the one or more processors, cause the system to:
monitor an event bus of a development environment, implemented on a user device, while a code document is open in the development environment;
detect, based on monitoring the event bus, a sequence of:
a first event indicative of a presentation, in the code document, of an inline element that contains candidate code, and
a second event indicative of an input into the user device for accepting the candidate code into the code document;
identify, subsequent to the sequence of the first event and the second event, that the code document contains the candidate code,
wherein detection of the sequence of the first event and the second event, and detection that the code document contains the candidate code is used to detect use of assistive coding in the code document;
detect an inclusion of the candidate code in a source code file in a code repository,
wherein the source code file is designated for deployment in a serving system;
determine, based on detecting the inclusion of the candidate code, a proportion of code in the source code file that used assistive coding; and
block, based on the proportion of code in the source code file satisfying a threshold, the source code file from deployment in the serving system.

2. A method for blocking deployment of unsatisfactory files using event detection, the method comprising:
monitoring, by a device, an event bus of a development environment, implemented on a user device, while a document is open in the development environment;
detecting, by the device, based on monitoring the event bus, a sequence of events indicative of use of assistive content generation to generate candidate content in the document;
detecting, by the device, an inclusion of the candidate content in a file in a file repository,
wherein the file is designated for deployment in a serving system; and
blocking, by the device and based on detecting the inclusion of the candidate content, the file from deployment in the serving system.

3. The method of claim 2, wherein detecting the sequence of events comprises:
detecting a first event indicative of a presentation, in the document, of an inline element that contains the candidate content; and
detecting a second event indicative of an input into the user device for accepting the candidate content into the document,
wherein detection of the sequence of the first event and the second event is used to detect use of assistive content generation.

4. The method of claim 3, further comprising:
identifying, subsequent to the sequence of the first event and the second event, that the document contains the candidate content,
wherein detection of the sequence of the first event and the second event, and detection that the document contains the candidate content, is used to detect use of assistive content generation in the document.

5. The method of claim 2, wherein detecting the sequence of events comprises:
detecting a first event indicative of a presentation, in the document, of an inline element,
wherein the first event is a first native event of the development environment;
normalizing the first native event to a first common event that is independent of any development environment,
wherein the first common event indicates the candidate content being shown;
detecting a second event indicative of an input into the user device,
wherein the second event is a second native event of the development environment;
normalizing the second native event to a second common event that is independent of any development environment,
wherein the second common event indicates acceptance of the candidate content;
and
determining, based on the first common event and the second common event, use of assistive content generation in the document.

6. The method of claim 2, wherein detecting the sequence of events comprises:
detecting a first event indicative of a first input into the user device relating to an input to an assistive system of the development environment; and
detecting a second event indicative of a second input into the user device for insertion of an output of the assistive system into the document,
wherein detection of the sequence of the first event and the second event is used to detect use of assistive content generation.

7. The method of claim 2, wherein monitoring the event bus comprises:
monitoring the event bus using an event listener of an extension of the development environment.

8. The method of claim 7, wherein the candidate content is generated by an additional extension of the development environment.

9. The method of claim 2, wherein detecting the inclusion of the candidate content in the file in the file repository comprises:
monitoring the file repository for modifications to a plurality of files in the file repository;
detecting, based on monitoring the file repository, a modification to the file; and
detecting, based on detecting the modification to the file, the inclusion of the candidate content in the file.

10. The method of claim 2, further comprising:
caching the candidate content with an association to a user of the user device.

11. The method of claim 10, wherein detecting the inclusion of the candidate content in the file in the file repository comprises:
detecting that a modification to the file is made by the user; and
retrieving the candidate content from a cache based on the association to the user.

12. The method of claim 2, further comprising:
determining, based on detecting the inclusion of the candidate content, a proportion of content in the file that used assistive content generation; and
determining whether the proportion of the content satisfies a threshold,
wherein blocking the file from deployment comprises:
blocking the file from deployment based on the proportion of the content satisfying the threshold.

13. The method of claim 12, further comprising:
determining the threshold based on an experience level of a user of the user device.

14. The method of claim 2, wherein blocking the file from deployment in the serving system comprises:
receiving a request to deploy the file to the serving system; and
terminating the request.

15. The method of claim 2, wherein detecting the inclusion of the candidate content in the file in the file repository comprises:
detecting the inclusion of candidate code in a source code file of a code repository.

16. The method of claim 15, wherein detecting the inclusion of candidate code in the source code file of the code repository comprises:
detecting a commit to the code repository;
comparing new code of the commit with candidate code snippets that have been detected within a threshold time before detection of the commit; and
determining, based on comparing the new code with the candidate code snippets, that the candidate code is present in the new code.

17. A non-transitory, computer-readable medium, comprising instructions that, when executed by one or more processors, cause operations comprising:
monitoring an event bus of a development environment, implemented on a user device, while a document is open in the development environment;
detecting based on monitoring the event bus, a sequence of events indicative of use of assistive content generation in the document to generate candidate content in the document,
wherein at least one event of the sequence of events includes an event indicative of an input into the user device; and
detecting use of assistive content generation in the document based on detecting the sequence of events.

18. The non-transitory, computer-readable medium of claim 17, wherein the instructions further cause operations comprising:
detecting an inclusion of the candidate content in a file in a file repository,
wherein the file is to be deployed in a serving system; and
blocking the file from deployment in the serving system based on detecting the inclusion of the candidate content.

19. The non-transitory, computer-readable medium of claim 17, wherein detecting the sequence of events comprises:
detecting a first event indicative of a presentation, in the document, of an inline element that contains the candidate content; and
detecting a second event indicative of an input into the user device for accepting the candidate content into the document,
wherein detection of the sequence of the first event and the second event is used to detect use of assistive content generation.

20. The non-transitory, computer-readable medium of claim 17, wherein detecting the sequence of events comprises:
detecting a first event indicative of a first input into the user device relating to an input to an assistive system of the development environment; and
detecting a second event indicative of a second input into the user device for insertion of an output of the assistive system into the document,
wherein detection of the sequence of the first event and the second event is used to detect use of assistive content generation.
